(19) United States
(12) Patent Application Publication
(10) Pub. No.: US 2025/0319884 A1
(43) Pub. Date: Oct. 16, 2025

(54) SYSTEMS AND METHODS FOR ADAPTING AN ENVIRONMENT AND TRAVEL PLANS FOR A VEHICLE OCCUPANT USING MODELS

(71) Applicant: Toyota Motor Engineering & Manufacturing North America, Inc., Plano, TX (US)

(72) Inventors: Rohit Gupta, Santa Clara, CA (US); Benjamin Piya Austin, Saline, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/634,003

(22) Filed: Apr. 12, 2024

(51) Int. Cl. B60W 50/00; B60W 40/08; B60W 50/12; B60W 50/14; G06N 3/0475; G06V 20/59; G06V 40/16

(52) U.S. Cl. CPC B60W 50/0098; B60W 40/08; B60W 50/0097; B60W 50/12; B60W 50/14; G06N 3/0475; G06V 20/59; G06V 40/171; B60W 2040/0872; B60W 2040/089; B60W 2050/143; B60W 2050/146; B60W 2420/403; B60W 2540/21; B60W 2540/22; B60W 2540/221; B60W 2540/223; B60W 2556/10

(57) ABSTRACT

Systems, methods, and other embodiments described herein relate to adapting an environment and travel plans for a vehicle by estimating occupant states using multiple models within a virtual mode. In one embodiment, a method includes acquiring multi-modal data about a vehicle occupant within a virtual mode of a vehicle, and the multi-modal data includes a description of an environment and a location. The method also includes estimating a physiological state and an emotional state associated with the vehicle occupant and matching the physiological state and the emotional state with preference data using a learning model. The method also includes adapting a vehicle surrounding and a travel plan using a generative model for the physiological state and the emotional state within the virtual mode.

### TECHNICAL FIELD

The subject matter described herein relates, in general, to adapting an environment and travel plans during vehicle travel, and, more particularly, to adapting an environment and travel plans for a vehicle by estimating occupant states.

### BACKGROUND

Vehicles acquire sensor data to facilitate and execute various tasks during vehicle travel. For example, systems perceive objects such as vehicles, obstacles, pedestrians, and additional aspects of a surrounding environment with image data. Here, a camera can acquire information about the surrounding environment from which a system derives awareness about aspects of the surrounding environment. As such, sensor and image data can assist various circumstances for improving perceptions of the surrounding environment so that systems such as automated driving systems can plan and navigate accordingly with increased accuracy, thereby improving travel enjoyment and safety for occupants.

In one approach, the further awareness is developed by the vehicle about a surrounding environment, the better an operator can be supplemented with information to assist in driving and the better an automated system can control the vehicle to avoid hazards. Still, certain tasks lack awareness about occupant states lessening travel quality. For example, a system routes a vehicle through an optimal path that an operator finds disinteresting and sometimes even unsafe. In another example, systems misinterpret commands from an operator for a destination due to limited awareness about context and current states (e.g., vehicle states, occupant states, etc.). Therefore, systems assisting operators during travel encounter limitations with awareness about occupants that hamper travel experiences.

### SUMMARY

In one embodiment, example systems and methods relate to adapting an environment and travel plans for a vehicle by estimating occupant states using multiple models within a virtual mode. In various implementations, vehicle occupants that dream about destinations and travel environments (e.g., restaurants, monuments, buildings, etc.) have difficulties recalling actual geographical locations associated with the destinations. For example, an operator has an enjoyable dream about a restaurant they visited in the past near a city but do not recall the actual city and name of the restaurant. As such, the operator becomes frustrated and may waste time searching for the environment with a navigation system, a virtual assistant, etc. Accordingly, systems analyzing an occupant for estimating a dream are prone to inaccuracies and demand detailed feedback, thereby reducing travel enjoyment.

Therefore, in one embodiment, a prediction system estimates states for a vehicle occupant using a learning model and executes adaptations within a virtual mode using a generative model which improves travel experiences. In particular, the prediction system acquires multi-modal data (e.g., vocalized environment feedback, location inputs, etc.) about the vehicle occupant and estimates a physiological state and an emotional state using a learning model (e.g., a neural network (NN)). In one approach, the estimations involve matching the physiological and emotional states with preference data (e.g., prior inputs, historical selections, etc.). In this way, the prediction system measures sentiment and context about the vehicle occupant in relation to environments and vehicle travel, thereby improving system awareness. Furthermore, the prediction system adapts a vehicle surrounding and a travel plan using the generative model for the physiological and emotional states within the virtual mode. This allows generating audiovisual content and routes for the travel plan that are interesting and arousing the vehicle occupant in the virtual mode with a positive dream, thereby improving travel pleasure. Accordingly, the prediction system adapts the vehicle surrounding and the travel plan using estimated states so that vehicle travel mimics a dream that improves driving comfort.

In one embodiment, a prediction system for adapting an environment and travel plans for a vehicle by estimating occupant states using multiple models within a virtual mode is disclosed. The prediction system includes a memory storing instructions that, when executed by a processor, cause the processor to acquire multi-modal data about a vehicle occupant within a virtual mode of a vehicle, and the multi-modal data includes a description of an environment and a location. The instructions also include instructions to estimate a physiological state and an emotional state associated with the vehicle occupant and match the physiological state and the emotional state with preference data using a learning model. The instructions also include instructions to adapt a vehicle surrounding and a travel plan using a generative model for the physiological state and the emotional state within the virtual mode.

In one embodiment, a non-transitory computer-readable medium for adapting an environment and travel plans for a vehicle by estimating occupant states using multiple models within a virtual mode and including instructions that when executed by a processor cause the processor to perform one or more functions is disclosed. The instructions include instructions to acquire multi-modal data about a vehicle occupant within a virtual mode of a vehicle, and the multi-modal data includes a description of an environment and a location. The instructions also include instructions to estimate a physiological state and an emotional state associated with the vehicle occupant and matching the physiological state and the emotional state with preference data using a learning model. The instructions also include instructions to adapt a vehicle surrounding and a travel plan using a generative model for the physiological state and the emotional state within the virtual mode.

In one embodiment, a method for adapting an environment and travel plans for a vehicle by estimating occupant states using multiple models within a virtual mode is disclosed. In one embodiment, the method includes acquiring multi-modal data about a vehicle occupant within a virtual mode of a vehicle, and the multi-modal data includes a description of an environment and a location. The method also includes estimating a physiological state and an emotional state associated with the vehicle occupant and matching the physiological state and the emotional state with preference data using a learning model. The method also includes adapting a vehicle surrounding and a travel plan using a generative model for the physiological state and the emotional state within the virtual mode.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with adapting an environment and travel plans for the vehicle by estimating occupant states using multiple models.

FIG. 3 illustrates one example of an area surrounding the vehicle having adaptations within a virtual mode using estimated states and a generative model.

FIG. 4 illustrates one embodiment of a prediction system communicating with a remote system for adapting an environment and travel plans for the vehicle by estimating occupant states within the virtual mode through training multiple models.

FIG. 5 illustrates one embodiment of a method that is associated with estimating a physiological state and an emotional state using a learning model for adapting a vehicle surrounding and a travel plan.

### DETAILED DESCRIPTION

Systems, methods, and other embodiments associated with adapting an environment and travel plans for a vehicle by estimating occupant states using multiple models within a virtual mode are disclosed herein. In various implementations, systems generating virtual environments during vehicle travel lack sufficient awareness about the interests and states of vehicle occupants, thereby causing frustrations. For example, an operator has recurring dreams about visiting a desert store. As such, creating a virtual environment that recreates the dream and traveling by the desert store could improve travel enjoyment. In another example, the system misinterprets a vehicle occupant having motion sickness and travels to a destination through stop-n-go traffic, thereby increasing discomfort. Thus, systems having insufficient awareness about occupants can decrease travel enjoyment and even increase occupant stress.

Therefore, in one embodiment, a prediction system analyzes multi-modal data (e.g., vocalized environment feedback, location inputs, etc.) about the vehicle occupant and estimates physiological and emotional states associated with the vehicle occupant for matching with preference data using a learning model. The prediction system can identify locations and generate virtual environments within a virtual mode of the vehicle (e.g., a connected and automated vehicle (CAV)) using the estimated physiological and emotional states. Here, the virtual mode can be a dream mode where the vehicle occupant inputs a description of a recent dream (e.g., a scene, building, restaurant, etc.) using a human-machine interface (HMI), voice inputs, etc. for the multi-modal data. In one approach, the learning model (e.g., a neural network (NN), a data-driven model, etc.) analyzes the inputs to identify a location (e.g., a park, a diner, etc.) associated with the recent dream and automatically generates directions or autonomously takes the vehicle occupant to the location. For instance, the learning model predicts arousal and sentiment associated with the vehicle occupant by correlating data variability from a galvanic-response sensor with facial features extracted from an image. In this way, the prediction system improves the driving experience by automatically taking the vehicle occupant on an enjoyable trip.

Moreover, in one embodiment, the prediction system adapts a vehicle surrounding and a travel plan for the location using a generative model for the physiological and emotional states. For example, the prediction system uses the generative model to recreate a dream state for the travel plan that reduces negative parameters associated with the physiological and emotional states. The generative model may also create audiovisual content on a window display of the vehicle associated with the dream state. Accordingly, the prediction system transforms the vehicle surrounding and the travel plan during a virtual mode using estimated states to recreate the dream state that improves driving experiences and travel comfort.

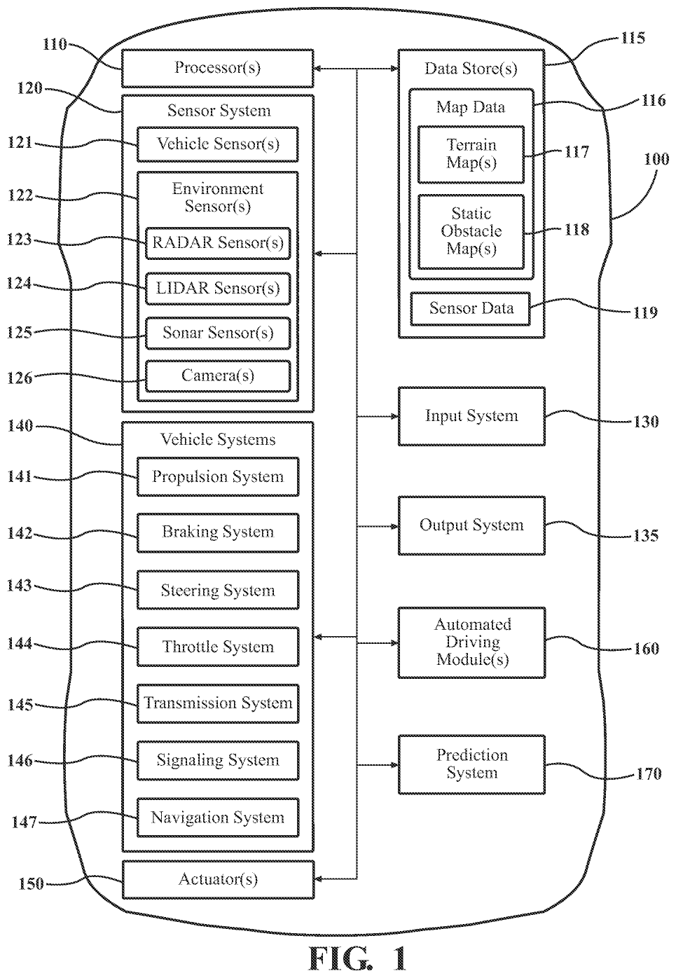

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, and so on that benefit from the functionality discussed herein associated with adapting an environment and travel plans for a vehicle by estimating occupant states using multiple models within a virtual mode.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

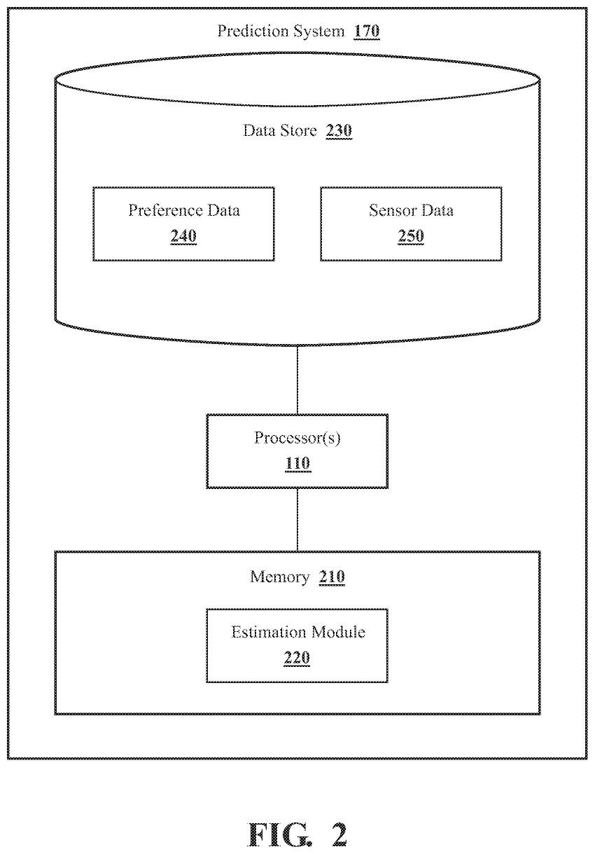

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes the prediction system 170 that is implemented to perform methods and other functions as disclosed herein relating to adapting an environment and travel plans for a vehicle by estimating occupant states using multiple models within a virtual mode.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores an estimation module 220. The memory 210 is a random-access memory (RAM), a read-only memory (ROM), a hard-disk drive, a flash memory, or other suitable memory for storing the estimation module 220. The estimation module 220 is, for example, computer-readable instructions that when executed by the processor(s) 110 cause the processor(s) 110 to perform the various functions disclosed herein.

The prediction system 170 as illustrated in FIG. 2 is generally an abstracted form of the prediction system 170. Furthermore, the estimation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the prediction system 170 and the estimation module 220, in one embodiment, acquire sensor data 250 that includes at least camera images. In further arrangements, the prediction system 170 and the estimation module 220 acquire the sensor data 250 from further sensors such as radar sensors 123, LIDAR sensors 124, and other sensors as may be suitable for identifying vehicles and locations of the vehicles.

Accordingly, the prediction system 170, in one embodiment, controls the respective sensors to provide the data inputs in the form of the sensor data 250. Additionally, while the prediction system 170 is discussed as controlling the various sensors to provide the sensor data 250, in one or more embodiments, the prediction system 170 can employ other techniques to acquire the sensor data 250 that are either active or passive. For example, the prediction system 170 passively sniffs the sensor data 250 from a stream of electronic information provided by the various sensors to further components within the vehicle 100. Moreover, the prediction system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. Moreover, the prediction system 170, in one embodiment, controls the sensors to acquire the sensor data 250 about an area that encompasses 360 degrees about the vehicle 100 in order to provide a comprehensive assessment of the surrounding environment. Of course, in alternative embodiments, the prediction system 170 may acquire the sensor data about a forward direction alone when, for example, the vehicle 100 is not equipped with further sensors to include additional regions about the vehicle and/or the additional regions are not scanned due to other reasons.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the estimation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the preference data 240 including historical selections by the vehicle occupant about dreams, thoughts, likes, dislikes, etc. As explained below, the prediction system 170 can factor the preference data 240 for estimating physiological and emotional states using a learning model.

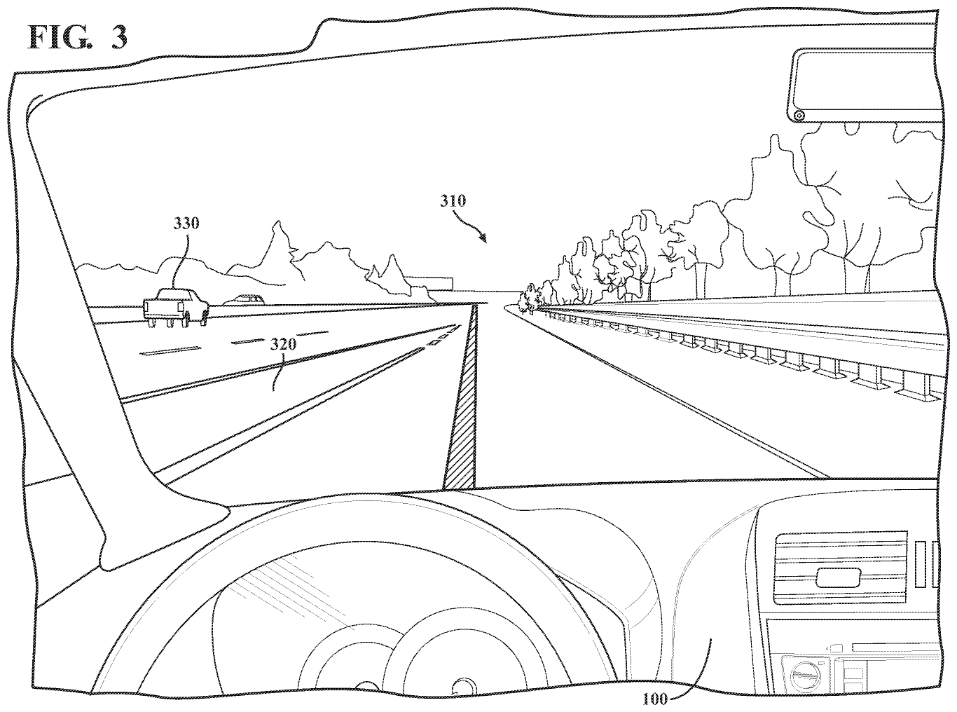

Now turning to FIG. 3, one embodiment of an area 310 surrounding a vehicle having adaptations within a virtual mode using estimated states and a generative model is illustrated. The prediction system 170 and the estimation module 220, in one embodiment, are further configured to perform additional tasks beyond controlling the respective sensors to acquire and provide the sensor data 250. For example, the prediction system 170 includes instructions that cause the processor 110 to acquire multi-modal data about a vehicle occupant within a virtual mode. Furthermore, the prediction system 170 estimates physiological and emotional states and matches the states with the preference data 240 using a learning model. In one approach, the prediction system 170 uses a machine learning (ML) algorithm, such as a convolutional NN (CNN), as the learning model that performs segmentation over the sensor data 250 from which further information is extracted and derived.

Moreover, in further aspects, the prediction system 170 may employ different machine learning algorithms or implements different approaches for performing the associated functions, which can include deep convolutional encoder-decoder architectures, or another suitable approach that generates semantic labels for the separate object classes represented in the sensor data 250. Whichever particular approach the prediction system 170 implements, the prediction system 170 provides an output with semantic labels identifying objects represented in the sensor data 250. Furthermore, the estimation module 220 can adapt a surrounding and a travel plan of the vehicle 100 using a generative model for the physiological and emotional states within the virtual mode. The generative model may be a ML model such as a generative pre-trained transformer (GPT). ML models such as GPT (e.g., GPT-3.5, GPT-4, etc.) can be large language models (LLM) that process prompts. For example, a transformer model of a NN uses attention rather than previous recurrence and convolution operations within a GPT. Attention mechanisms allow the GPT to selectively focus on segments of a textual prompt and identify contextual relationships, such as between textual forms of the sensor data 250 and the preference data 240.

In FIG. 3, the prediction system 170 can launch the virtual mode automatically while the vehicle 100 travels on the road 320 with the truck 330 using the preference data 240. In one approach, the virtual mode is a dream mode that soothes occupants during vehicle travel by passing favored locations and recreating dream environments, such as through one of augmented reality (AR) and virtual reality (VR) generated environments. The forthcoming examples reference a dream mode. However, the virtual mode can generally be associated with visions, thoughts, mind frames, etc., of the vehicle occupant. As further explained below, the prediction system 170 can recreate and mimic a dream state for a travel plan that reduces negative parameters from the physiological and emotional states that are estimated using a ML model. The estimation module 220 can subsequently generate audiovisual content on a window display of the vehicle using a generative model associated with or independent from the ML model according to the dream state.

Besides launching the virtual mode automatically, the vehicle occupant can also request that the prediction system 170 enter the virtual mode using a human-machine interface (HMI) within the vehicle 100, through voice activation, etc. Furthermore, inputs can include the vehicle occupant describing details about a dream such as a location they visited, a food eaten at a restaurant, scenery they witnessed, a building color, an environment layout, worker clothing, etc. upon entering the virtual mode. In this way, the prediction system 170 acquires multi-modal data about the vehicle occupant within the virtual mode for subsequently estimating physiological and emotional states about a dream, thought, etc. with improved accuracy.

In various implementations, the prediction system 170 estimates the physiological and emotional states by receiving continuous information from a galvanic-response sensor and an image from one or more camera(s) 126 (e.g., an in-vehicle camera) associated with the vehicle occupant. For example, the information includes pulse and temperature data (e.g., body temperature, surface temperature, etc.) acquired from a galvanic-response sensor of a smartwatch and stored in the sensor data 250. In another example, pulse and temperature data are acquired from sensors located on the steering wheel, seats, etc. Irrespective of sensor placement, the prediction system 170 can estimate physiological and emotional states (e.g., stress, fight or flight, etc.) through measuring pulse and temperature data variability, thereby improving the recreation of a dream state using the estimated states.

Additionally, the prediction system 170 may derive facial features of the vehicle occupant from the image using the ML model and predict arousal and sentiment, such as by correlating the variability of the information with the facial features. As such, the physiological and emotional states can be derived from measured responses that are one of eye movement, gaze estimates, galvanic skin inputs, conversational responses, tone, and audible sentiment for replicating a dream state. Details about the physiological and emotional states assisting the prediction system 170 with preventing maneuvers during the travel plan that reduce a safety parameter can include removing negative responses from the states. Through these actions the prediction system 170 can also estimate the intent of the vehicle occupant for making recommendations and mimicking the dream state.

In one approach, the prediction system 170 adjusts hyperparameters of the ML model continuously through factoring the facial features that reduce stress data outputted by the galvanic-response sensor. For instance, the prediction system 170 rewards the ML model and adjusts the hyperparameters towards values that increase happiness, sadness, etc. values for the vehicle occupant. A hyperparameter can be a parameter (e.g., learning rate, optimizer, etc.) which systems tune during a learning process for a ML model that increases accuracy, such as during implementation after training. In this way, the ML model can accurately replicate and mimic a dream through systems of the vehicle 100 and increase driving pleasure by reducing stress.

Regarding details about adapting the vehicle surrounding and the travel plan during the virtual mode, the prediction system 170 can estimate the physiological and emotional state associated with a dream state for the estimation module to generate the vehicle surrounding and the travel plan. For instance, the prediction system 170 infers that the vehicle occupant is describing a 70s diner from a dream and develops the travel plan (e.g., directions) for visiting a similar diner. As another example, the prediction system 170 locates a listing of parks that matches the descriptions from the occupant about a similar park and creates a travel plan using feedback from the vehicle occupant. Here, the prediction system 170 can utilize the automated driving module(s) 160 and autonomously takes the vehicle occupant to the location when commanded. Furthermore, the estimation module 220 can produce interactive commentary and interactive narration about the dream state using the generative model for the travel plan, such as with the preference data 240. For instance, the estimation module 220 generates virtual scenes using AR and VR on windshield or window displays from the vehicle 100 that mimic features of a dream state. This can involve a GPT model describing the dream state through the travel plan using media such as audio, video, images, etc.

In various implementations, the prediction system 170 matches the preference data 240 using the ML model with a dream state associated with estimating the physiological and emotional states for recreating environments. For example, the ML model receives details about a dog, a house, and a tree from a vehicle occupant describing a dream. The vehicle 100 subsequently travels to a dog park while generating a virtual environment on glass displays of a childhood house associated with the vehicle occupant. Furthermore, the prediction system 170 can adapt the ML model while following the travel plan for aligning detected intent and comfort about the dream state with the destination through hyperparameters as previously explained. For instance, the prediction system 170 reroutes the destination from the dog park to a pet store when stress levels estimated from temperature and pulse data are increasing and sentiment metrics are decreasing.

The dream mode can include features that manage estimated stress levels of a vehicle occupant while generating a dream state and a travel plan. For example, the prediction system 170 infers that a travel stop will reduce stress (e.g., a headache, unhappiness, etc.) with a ML model using data outputted by a galvanic-response sensor. In response, the prediction system 170 adds the travel stop (e.g., a pharmacy, a convenience store, etc.) to the travel plan and updates virtual surroundings for the travel stop, thereby reducing stress levels. As added safety, the prediction system 170 can also exclude portions of dream states that involve hallucination, intoxication (e.g., drugs, alcohol, etc.), etc. from vehicle surrounding generated and the travel plan, such as for safety. In this way, the prediction system adapts the vehicle surrounding and the travel plan for estimated physiological and emotional states within the virtual mode that further improve travel comfort.

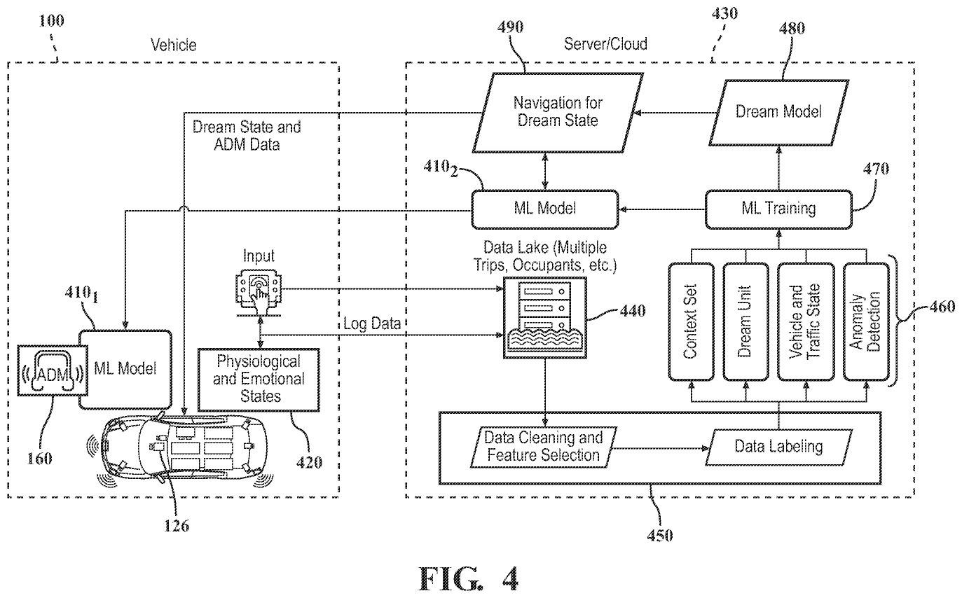

Now turning to FIG. 4, the prediction system 170 communicating with a remote system for adapting an environment and travel plans for the vehicle 100 by estimating occupant states within a virtual mode through training multiple models is illustrated. As explained below, the vehicle 100 includes a ML model 4101 that estimates physiological and emotional states associated with a dream state through the prediction system 170. The vehicle 100 also includes front radar, corner, and camera(s) 126 that partially generate the sensor data 250. The prediction system 170 can also capture the physiological and emotional states 420 about a vehicle occupant using inputs and store the states within a logger(s) 1-5. The vehicle 100 can communicate log data from the logger(s) 1-5, the inputs, and the sensor data 250 to the data lake 440 within the server/cloud 430. The data lake 440 can store data from multiple trips, occupants, etc. In one approach, the server/cloud 430 cleans and selects features (e.g., keypoints, boundaries, etc.) and labels data using stored from the data lake 440 using the processing stage 450. The remote processing 460 subsequently has a context set (e.g., highway travel, inexperienced operator, etc.), dream unit, vehicle and traffic states (e.g., congested road, parked vehicle, etc.), and anomaly detection (e.g., animal crossing, sudden weather change, etc.) that structures and organizes the labeled data for ML training 470.

In FIG. 4, the ML training 470 can provide weights and parameters to adjust a ML model 4102 and a dream model 480 (e.g., a generative model). Furthermore, navigation for a dream state 490 can adapt a travel plan using outputs from the ML model 4102 and the dream model 480. Subsequently, the server/cloud 430 communicates to the vehicle 100 details about virtually generating a surrounding environment and path plans associated with a dream state from the navigation for the dream state 490. After training, the server/cloud 430 also communications automated driving module data for replacing the ML model 4101 with ML model 4102 trained with the log data, inputs, the sensor data 250, etc. Accordingly, the server/cloud 430 can facilitate the dream mode through leveraging additional computing resources with remote computations and train the ML model and the dream model, thereby improving system performance and robustness.

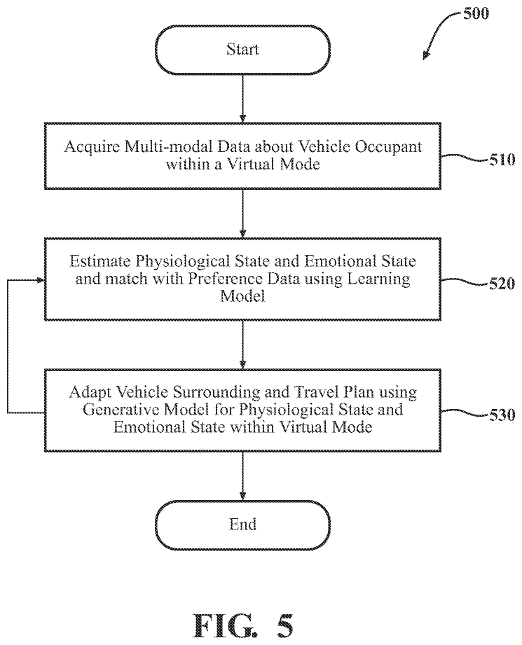

Regarding FIG. 5, a flowchart of a method 500 that is associated with estimating a physiological state and an emotional state using a learning model for adapting a vehicle surrounding and a travel plan is illustrated. Method 500 will be discussed from the perspective of the prediction system 170 of FIGS. 1 and 2. While method 500 is discussed in combination with the prediction system 170, it should be appreciated that the method 500 is not limited to being implemented within the prediction system 170 but is instead one example of a system that may implement the method 500.

At 510, the prediction system 170 acquires multi-modal data about a vehicle occupant within a virtual mode. Here, the multi-modal data can include voice, touch inputs, facial features, responses derived from image data, etc., stored in the sensor data 250. The virtual mode may be a dream mode that soothes occupants during vehicle travel by passing favored locations and recreating dream environments, such as through AR, VR, etc., generated environments. The virtual mode can also generally be associated with visions, thoughts, mindframes, etc., of the vehicle occupant. Furthermore, responses can include one of eye movement, gaze estimates, galvanic skin inputs, conversational responses, tone, and audible sentiment estimated with the sensor data 250. As previously explained, the prediction system 170 can estimate pulse and temperature data (e.g., body temperature, surface temperature, etc.) using data acquired from a galvanic-response sensor. For instance, the pulse and temperature data are acquired from sensors located on a smartwatch, a steering wheel, seats, etc. Irrespective of sensor placement, the prediction system 170 can estimate physiological and emotional states (e.g., stress, fight or flight, etc.) through measuring pulse and temperature data variability, thereby improving the recreation of a dream state.

At 520, the prediction system 170 estimates physiological and emotional states that match with the preference data 240 using a learning model (e.g., a data-driven model, NN, etc.). In one approach, the preference data 240 includes user data, historical selections, etc. by the vehicle occupant about dreams, thoughts, likes, dislikes, etc. For generating the dream state, the prediction system 170 can estimate physiological and emotional states (e.g., stress, fight or flight, etc.) through measuring pulse and temperature data variability using the galvanic response sensor. In one approach, the prediction system 170 derives facial features of the vehicle occupant from the image using the ML model and predict arousal and sentiment. As previously described, in this way the prediction system 170 can estimate the physiological and emotional states from one of eye movement, gaze estimates, galvanic skin inputs, conversational responses, tone, and audible sentiment.

Furthermore, as previously explained, in one embodiment the prediction system 170 matches the preference data 240 using the ML model with a dream state by relating disparate descriptions associated with recreating environments. For example, the ML model receives details about a dog, a house, and a park from a dream. The prediction system 170 subsequently estimates from the physiological and emotional states that the vehicle occupant wishes to travel to a dog park while viewing a childhood house including the dog associated with the vehicle occupant.

At 530, the estimation module 220 adapts a vehicle surrounding and a travel plan using a generative model for the physiological and emotional states within the virtual mode. As previously explained, the prediction system 170 can estimate the physiological and emotional states associated with a dream state and the estimation module can generate the vehicle surrounding and the travel plan accordingly. For example, the prediction system 170 locates a listing of parks that matches the descriptions from the occupant about a similar park and creates the travel plan using feedback from the vehicle occupant. The estimation module 220 can adapt the vehicle surrounding and produce interactive commentary and interactive narration about the dream state using the generative model for the travel plan. For instance, the estimation module 220 generates virtual scenes using AR and VR on windshield or window displays of the vehicle 100 that mimic features about a dream state. Here, the GPT model may utilize the physiological and emotional states for generating content describing the dream state through the travel plan that includes media such as audio, video, images, etc.

In various implementations, the prediction system 170 adapts the ML model while following the travel plan for aligning detected intent and the dream state with the destination. For instance, the prediction system 170 changes the destination from park to a previous residence when sentiment levels estimated from voice data are decreasing about the travel plan including the park. In one approach, the prediction system 170 continuously adapts estimated physiological and emotional states as the preference data 240 and the sensor data 250 change from feedback. In this way, the estimation module 220 adapts the vehicle surrounding and the travel plan using the generative model with accurate information. Accordingly, the prediction system improves vehicle travel through virtually adapting a vehicle surrounding and a travel plan that recreate features of a dream state using estimated physiological and emotional states.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5 but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
acquire multi-modal data about a vehicle occupant within a virtual mode of a vehicle, and the multi-modal data includes a description of an environment and a location;
estimate a physiological state and an emotional state associated with the vehicle occupant and match the physiological state and the emotional state with preference data using a learning model; and
adapt a vehicle surrounding and a travel plan using a generative model for the physiological state and the emotional state within the virtual mode.

2. The prediction system of claim 1, wherein the instructions to estimate the physiological state and the emotional state further include instructions to:
receive continuously information from a galvanic-response sensor and an image from a camera associated with the vehicle occupant, wherein the information includes pulse data and temperature data;
derive facial features of the vehicle occupant from the image using the learning model; and
predict arousal and sentiment associated with the vehicle occupant by correlating variability of the information with the facial features.

3. The prediction system of claim 2, wherein the instructions to derive the facial features further include instructions to:
adjust hyperparameters of the learning model continuously according to the facial features that reduce stress data outputted by the galvanic-response sensor.

4. The prediction system of claim 2 further including instructions to:
predict by the learning model a travel stop that will reduce stress data outputted by the galvanic-response sensor; and
add the travel stop to the travel plan and update the vehicle surrounding for the travel stop.

5. The prediction system of claim 1, wherein the instructions to adapt the vehicle surrounding and the travel plan further include instructions to:
recreate a dream state for the travel plan that reduces negative parameters associated with the physiological state and the emotional state; and
generate audiovisual content on a window display of the vehicle using the generative model, wherein the generative model is a generative pre-trained transformer (GPT) model.

6. The prediction system of claim 1, wherein the instructions to adapt the vehicle surrounding and the travel plan further include instructions to:
produce interactive commentary and interactive narration about the physiological state and the emotional state using the generative model.

7. The prediction system of claim 1, wherein the instructions to estimate the physiological state and the emotional state further include instructions to:
prevent maneuvers during the travel plan that reduce a safety parameter by removing negative states from the physiological state and the emotional state.

8. The prediction system of claim 1, wherein the physiological state and the emotional state include responses that are one of eye movement, gaze estimates, galvanic skin inputs, conversational responses, tone, and audible sentiment.

9. The prediction system of claim 1, wherein:
the preference data includes historical selections by the vehicle occupant;
the virtual mode is one of an augmented reality (AR) mode and a virtual reality (VR) mode; and
the learning model is one of a neural network and data-driven model.

10. A non-transitory computer-readable medium comprising:
instructions that when executed by a processor cause the processor to:
acquire multi-modal data about a vehicle occupant within a virtual mode of a vehicle, and the multi-modal data includes a description of an environment and a location;
estimate a physiological state and an emotional state associated with the vehicle occupant and match the physiological state and the emotional state with preference data using a learning model; and
adapt a vehicle surrounding and a travel plan using a generative model for the physiological state and the emotional state within the virtual mode.

11. The non-transitory computer-readable medium of claim 10, wherein the instructions to estimate the physiological state and the emotional state further include instructions to:
receive continuously information from a galvanic-response sensor and an image from a camera associated with the vehicle occupant, wherein the information includes pulse data and temperature data;
derive facial features of the vehicle occupant from the image using the learning model; and
predict arousal and sentiment associated with the vehicle occupant by correlating variability of the information with the facial features.

12. A method comprising:
acquiring multi-modal data about a vehicle occupant within a virtual mode of a vehicle, and the multi-modal data includes a description of an environment and a location;
estimating a physiological state and an emotional state associated with the vehicle occupant and matching the physiological state and the emotional state with preference data using a learning model; and
adapting a vehicle surrounding and a travel plan using a generative model for the physiological state and the emotional state within the virtual mode.

13. The method of claim 12, wherein estimating the physiological state and the emotional state further includes:
receiving continuously information from a galvanic-response sensor and an image from a camera associated with the vehicle occupant, wherein the information includes pulse data and temperature data;
deriving facial features of the vehicle occupant from the image using the learning model; and
predicting arousal and sentiment associated with the vehicle occupant by correlating variability of the information with the facial features.

14. The method of claim 13, wherein deriving the facial features further includes:
adjusting hyperparameters of the learning model continuously according to the facial features that reduce stress data outputted by the galvanic-response sensor.

15. The method of claim 13 further comprising:
predicting by the learning model a travel stop that will reduce stress data outputted by the galvanic-response sensor; and
adding the travel stop to the travel plan and updating the vehicle surrounding for the travel stop.

16. The method of claim 12, wherein adapting the vehicle surrounding and the travel plan further includes:
recreating a dream state for the travel plan that reduces negative parameters associated with the physiological state and the emotional state; and
generating audiovisual content on a window display of the vehicle using the generative model, wherein the generative model is a generative pre-trained transformer (GPT) model.

17. The method of claim 12, wherein adapting the vehicle surrounding and the travel plan further includes:
producing interactive commentary and interactive narration about the physiological state and the emotional state using the generative model.

18. The method of claim 12, wherein estimating the physiological state and the emotional state further includes:
preventing maneuvers during the travel plan that reduce a safety parameter by removing negative states from the physiological state and the emotional state.

19. The method of claim 12, wherein the physiological state and the emotional state include responses that are one of eye movement, gaze estimates, galvanic skin inputs, conversational responses, tone, and audible sentiment.

20. The method of claim 12, wherein;
the preference data includes historical selections by the vehicle occupant;
the virtual mode is one of an augmented reality (AR) mode and a virtual reality (VR) mode; and
the learning model is one of a data-driven model and a neural network.
